(19) United States
(12) Patent Application Publication
(10) Pub. No.: US 2011/0135864 A1
(43) Pub. Date: Jun. 9, 2011

(54) ADHESIVE TAB FOR A TABBER

(75) Inventors: Robert STAHL, Herbrechtingen (DE); Martin LASINGER, Sauerlach (DE)

(73) Assignee: NEOPOST TECHNOLOGIES, Bagneux (FR)

(21) Appl. No.: 12/942,773

(22) Filed: Nov. 9, 2010

(30) Foreign Application Priority Data
Nov. 10, 2009 (EP) 09 306 082.0

(51) Int. Cl. G09F 3/02; B32B 7/12; B32B 3/10; C09J 7/02; B42C 9/00; B65C 5/00

(52) U.S. Cl. 428/42.3; 428/43; 428/57

(57) ABSTRACT

In a tabber device suitable for sealing folded material by means of an adhesive tab provided with a theoretical fold line, the tab has at least two series of perforations distributed along at least three parallel lines, one of which coincides with the theoretical fold line, with the other two being disposed on either side of the theoretical fold line.

### FIELD OF THE INVENTION

The invention relates to a tabber, i.e. an appliance for sealing folded material such as a brochure with one or more adhesive tabs.

### PRIOR ART

Conventionally, a brochure comprises one or more printed sheets that are folded once or twice by a folder so as to form folded material ready for dispatching. The folded material has a folded end and an open end that is usually sealed by one or more adhesive fasteners in the form of tabs, which tabs are often transparent. Furthermore, it may be necessary to apply or print an address and a postage mark on the brochure in order to enable it to be dispatched to its destination via a conventional postage distribution network.

Tabbing machines (tabbers) for preparing such folded material are well known. For example, U.S. Pat. No. 5,279,698 (Davis) describes a tabber appliance for putting a tab on the open end of folded material such as a brochure. Typically, the tabs that are used for sealing the folded material are pre-perforated over their entire length and they are disposed on a strip of support material from which they can be separated. During the tabbing process, a tab is separated from the support material and its adhesive portion that was in contact with the support material is then folded into two symmetrical portions that are put into contact with the open end of the folded material.

The main drawback of tabbing appliances using pre-perforated tabs is that they need to be fitted with mechanical means or optical means that are complex in order to position the tab accurately at the open end of the folded material. If the tab is not properly centered on the edge formed by the open end, then it is found that the tab is difficult to remove by being parted or broken without prior deformation of the folded material; this operation often runs the risk of spoiling or tearing the folded material.

Another major drawback lies in the need to change the tabber or the production line when the succession of perforations in the tabs runs parallel or transversely to the travel direction of the articles for closing, depending respectively on whether the tab is laid flat on the article or is folded and fastened to the edge thereof.

### OBJECTS AND SUMMARY OF THE INVENTION

It is therefore desirable to find a solution that does not require recourse to such positioning means that are complex and therefore expensive in order to place a tab correctly on the edge forming the open end of the folded material, thus enabling tabber appliances to be made at lower cost and also making it easier to open the folded material manually as though using a paper knife.

These objects are achieved by a tab for a tabber device suitable for sealing a folded material by means of an adhesive tab provided with a theoretical fold line, wherein the tab includes at least two series of perforations distributed along at least three parallel lines, one of which coincides with said theoretical fold line, with the other two being disposed on either side of and at equal distances from said theoretical fold line.

Thus, with these three lines of perforations, a certain amount of tolerance is made available about the theoretical fold line for putting the tab into place, but without harming the robustness of a tab since the perforations are in discontinuous series.

Said at least two series of perforations may be two in number, being disposed on an axis running along said theoretical fold line and being as close as possible to an outside edge of said tab or indeed they may be three in number or six in number being regularly distributed along an axis passing along said theoretical fold line.

The tab may advantageously be round in shape and it may also include a central opening, and said series of perforations may be four in number, each of these four series of perforations being disposed along an axis passing through said central opening and each being located as close as possible to a respective inside or outside edge of said tab.

The two series of perforations in said four series of perforations that are disposed the closest to said outside edge of the tab may touch said outside edge so as to create two series of notches.

Preferably, the distance between two adjacent series of perforations is about ten times greater than the length of each of said perforations forming each of said two series of perforations.

Advantageously, said series of perforations are arranged along two perpendicular directions.

The invention also provides the support strip for unreeling for use in a tabber and having a plurality of tabs as described above stuck thereto.

### BRIEF DESCRIPTION OF THE DRAWINGS

The characteristics and advantages of the present invention appear better from the following description made by way of non-limiting indication and with reference to the accompanying drawings, in which:

FIGS. 1 to 4 show various embodiments of a support strip for adhesive tabs of the invention;

FIG. 5 shows a document sealed in two locations by two adhesive tabs of the invention; and

FIG. 6 shows a brochure sealed by a prior art adhesive tab.

### DETAILED DESCRIPTION OF A PREFERRED EMBODIMENT

As shown in FIG. 6, a folded material such as a brochure 10 has a folded end 12 and an open end 14 that is sealed in the example shown by a single adhesive tab 16. Naturally, sealing by means of a plurality of tabs is also common practice. The adhesive tab shown is round, even though it is possible to envisage some other shape, and it includes a central fold line 16A that may be perforated along its entire length in order to make it easier to tear. Nevertheless, the adhesive tab needs to be strong enough to withstand the various treatments to which the brochure might be subjected during the process of distributing it, and once in place, the perforated line 16A must coincide accurately with the edge of the open end so as to enable the person opening the brochure to open it easily by passing a finger therealong, for example.

As is known, adhesive tabs are stuck to brochures by means of a tabber having one or more spools delivering strips 18 for unwinding, such strips having several thousand adhesive tabs placed side by side thereon, each tab having an adhesive face in contact with the support strip, which adhesive face is used, after the tab has been removed from the strip, for sealing the brochure, and the tab has an opposite face that is not adhesive. Conventionally, such a tab is made of transparent polyethylene and it is stuck on a silicone-treated support strip. Regularly spaced-apart sprocket holes 18A are also provided in the support strip to enable it to be driven through the tabber.

In accordance with the invention, the adhesive tabs 20 no longer have a single central line that is perforated along its entire length, but rather it has a plurality of series of short perforations distributed along at least two parallel lines 22, 24, and 26 centered on the theoretical central fold line of the tab. Thus, with the invention, it is no longer necessary to use complex mechanical or optical means to cause the fold line to coincide with the edge of the open end of the folded material, since a small offset to one side or the other of said central line still allows the edge to be in alignment with one or the other of the parallel perforations located on either side of said theoretical fold line, and thus allows the person receiving the folded material to tear the tab easily. Furthermore, since the perforations do not run along the entire length of the fold but are limited merely to certain predetermined zones along said fold line, the robustness of the tab is unaffected in spite of having two additional lines of perforations. It should be observed that this configuration with two lines of perforations is not limiting and the invention could equally well have a greater number, e.g. three as shown in the figures, or even more, e.g. four or five, providing that they do not degrade the general robustness of the tab.

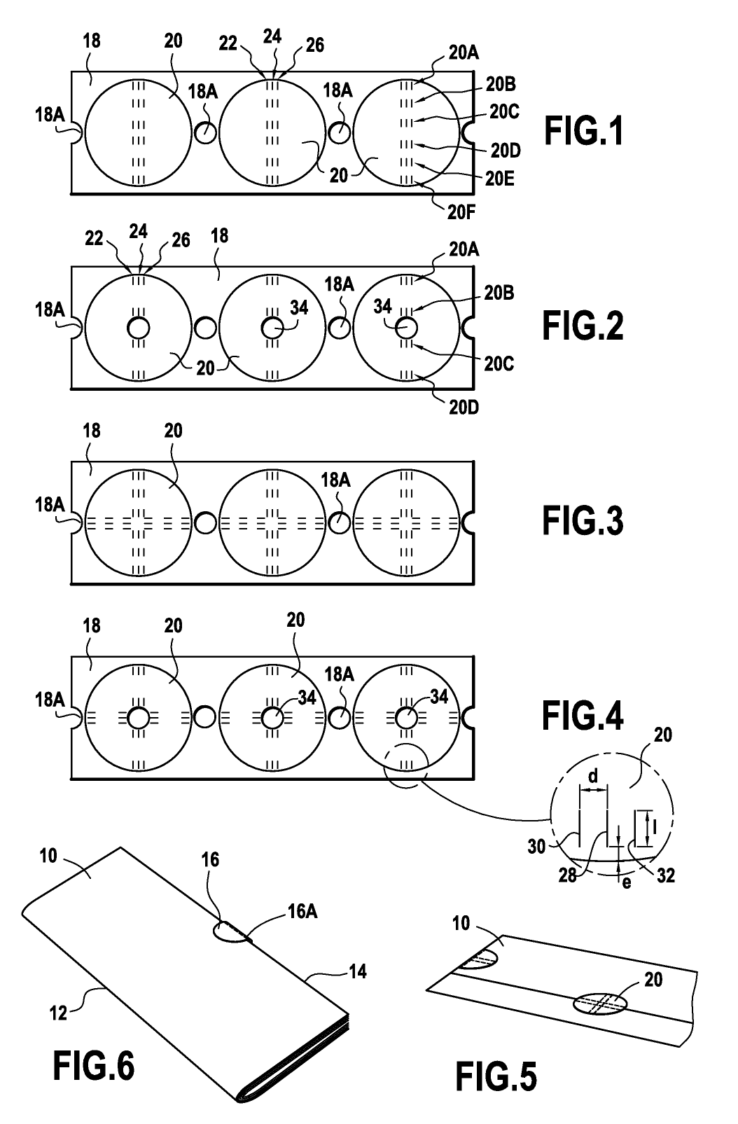

In the example shown in FIG. 1, the tab 20 has six series 20A, 20B, 20C, 20D, 20E, and 20F of perforations each series having three perforations comprising a central perforation 28 and two lateral perforations 30, 32 on either side thereof. These six series are uniformly distributed along a diameter of the tab, and in each series the two lateral perforations 30, 32 are disposed on either side of and at equal distances d from the central perforation 28 that coincides with the theoretical central fold line of the tab.

Thus, by way of example, for a tab having a diameter of 25 millimeters (mm), perforations with a length of 0.5 mm spaced apart by 1 mm are formed every 4 mm (the two ends being positioned at 1 mm from the periphery of the tab). It should be observed that there is a large ratio, of the order of 10, between the length of the perforations (0.5 mm) and the spacing between two series of perforations (4 mm), with this being necessary to guarantee some minimal level of robustness for the tab.

In the example shown in FIG. 2, the tab 20 is in the form of an eyelet having a central opening 34 so that it only has four series of perforations 20A, 20B, 20C, and 20D, each series comprising three perforations comprising a central perforation 28 and two lateral perforations 30, 32 disposed on either side of and at equal distances d from the central perforation 28 that coincides with the theoretical central fold line of the tab. These four series of perforations are disposed along an axis passing through the central opening (physically a diameter of the tab) and as close as possible to each inside or outside edge of the eyelet (indeed two of them touch the outside edge, thereby creating two series of three notches).

Thus, for example, for a tab having an outside diameter of 25 mm and an inside diameter of 5 mm, three perforations of length l equal to 0.5 mm spaced apart from one another by 1 mm are made at a distance e lying in the range 0.2 mm to 0.8 mm from said edges (or indeed 0 mm for the outer edge).

It should be observed that although the perforations shown are in the form of rectangular slots, it is clear that a succession of fine circular perforations would be equally suitable. Similarly, although the perforations are shown as being made in series, it is not impossible to envisage that they are made along the entire diameter of the tab, providing that the size of the slots still enables the tab to be guaranteed sufficient robustness.

FIGS. 3 and 4 show examples that are variant embodiments of the preceding examples in which the perforations are formed in two perpendicular directions enabling the tabs to be used on two different types of tabber, horizontal axis tabbers and vertical axis tabbers, or indeed, for a given machine, enabling closure to be performed on an open end of a folded document, as described above, or else flat on a document that is folded to present a flap (see FIG. 5). The structure of the tab of the invention is thus very flexible in use depending on the type of tabber available and on the type of closure selected.

Naturally, the present invention is not limited to only those shapes of tab that are shown in the figures (mainly circular or annular). It is perfectly clear that a shape that is square, rectangular, or oval would be equally suitable. Similarly, although the version shown with four series, each of three parallel lines of perforations, appears to be the best for reconciling robustness in transport and ease of opening by the recipient, it is entirely possible to imagine an alternative with three or even two series of perforations centered on the theoretical fold line and distributed regularly along a diameter of the tab (three series), or disposed closer to its periphery (two series).

What is claimed is:

1. A tab for a tabber device suitable for sealing a folded material by means of an adhesive tab provided with a theoretical fold line, wherein the tab includes at least two series of perforations distributed along at least three parallel lines, one of which coincides with said theoretical fold line, with the other two being disposed on either side of and at equal distances from said theoretical fold line.

2. A tab according to claim 1, wherein said at least two series of perforations are two in number, being disposed on an axis running along said theoretical fold line, and being as close as possible to an outside edge of said tab.

3. A tab according to claim 1, wherein said at least two series of perforations are three in number, being regularly distributed along an axis extending along said theoretical fold line.

4. A tab according to claim 1, wherein said at least two series of perforations are six in number, being regularly spaced apart along an axis passing along said theoretical fold line.

5. A tab according to claim 1, including a central opening, and said series of perforations are four in number, each of these four series of perforations being disposed along an axis passing through said central opening and each being located as close as possible to a respective inside or outside edge of said tab.

6. A tab according to claim 5, wherein the two series of perforations in said four series of perforations that are disposed the closest to said outside edge of the tab touch said outside edge so as to create two series of notches.

7. A tab according to claim 1, wherein the distance between two adjacent series of perforations is about ten times greater than the length of each of said perforations forming each of said two series of perforations.

8. A tab according to claim 1, wherein said series of perforations are arranged along two perpendicular directions.

9. A tab according to claim 1, that is round in shape.

10. A support strip for unreeling having a plurality of tabs according to claim 1 stuck thereto.
